(19) United States
(12) Patent Application Publication
(10) Pub. No.: US 2016/0140655 A1
(43) Pub. Date: May 19, 2016

(54) SYSTEM AND METHOD FOR AUTOMATICALLY VERIFYING USER INFORMATION FOR USE IN UNDERWRITING

(71) Applicant: MasterCard International Incorporated, Purchase, NY (US)

(72) Inventor: Shekhar Sahgal, Stamford, CT (US)

(21) Appl. No.: 14/543,178

(22) Filed: Nov. 17, 2014

(51) Int. Cl. G06Q 40/02

(52) U.S. Cl. CPC G06Q 40/025

(57) ABSTRACT

According to some embodiments, an applicant may be identified at a lender. One or more existing payment products of the applicant may be identified. Information associated with each payment product may then be transmitted to a network. Transaction information associated with each payment product may then be received from a transaction database, for use in underwriting. Numerous other aspects are provided.

### FIELD OF THE INVENTION

The present invention relates to consumer lending, and more particularly to credit scoring and the like.

### BACKGROUND

When a consumer applies for a loan at a lender, lenders typically obtain credit scores from the three major credit bureaus (e.g., Equifax®, Experian®, and TransUnion®). However, there are consumers that do not have a credit score or history, and/or do not have a good credit score. As a result, systems and methods to obtain additional information about a consumer to evaluate the consumer's credit worthiness may be desired.

### SUMMARY OF THE INVENTION

In certain aspects of the invention, a method is provided for use in underwriting. The method comprises: identifying an applicant at a lender; identifying one or more existing payment products of the applicant; transmitting information associated with each payment product to a network; and receiving, from a transaction database, transaction information associated with each payment product for use in underwriting.

In another aspect of the invention, a non-transitory, computer-readable medium having stored therein instructions that, upon execution, cause a computer processor to perform a method is provided. The method comprises: identifying an applicant at a lender; identifying one or more existing payment products of the applicant; transmitting information associated with each payment product to a network; and receiving, from a transaction database, transaction information associated with each payment product for use in underwriting.

Another aspect of the invention provides an apparatus for use in underwriting. The apparatus comprises: a transaction database storing transaction information associated with one or more payment products; and a credit evaluation platform to: (i) identify an applicant at a lender, (ii) identify one or more existing payment products of the applicant, (iii) transmit information associated with each payment product to a network, and (iv) receive, from a transaction database, transaction information associated with each payment product for use in underwriting.

Other features and aspects of the present invention will become more fully apparent from the following detailed description, the appended claims and the accompanying drawing.

### BRIEF DESCRIPTION OF THE DRAWINGS

FIG. 1 is a block diagram overview of a system according to some embodiments of the present invention.

FIG. 2 illustrates a method that might be performed in accordance with some embodiments.

FIG. 3 is a block diagram of a model/tool or platform according to some embodiments of the present invention.

FIG. 4 is a tabular portion of a transaction database according to some embodiments.

FIG. 5 is an example of a display that might be provided in accordance with some embodiments.

### DETAILED DESCRIPTION

Consumers that have no credit file (e.g., people with no credit history and therefore no credit score) or a thin credit file (e.g., people without enough of a credit history to generate a credit score), or have a poor credit rating/score may be referred to as “financially underserved” consumers, and may have trouble getting a loan.

When a consumer/applicant applies for a loan at a lender, lenders typically use a consumer's social security number to request and obtain a credit history report (e.g. credit scores) from the three major credit bureaus (e.g., Equifax®, Experian®, and TransUnion®). However, there are consumers (e.g. unbanked, immigrants, foreign students and young adults) that may not have a U.S. credit history. Other consumers do not have a credit score or history as they have not had to use any credit or borrow money (e.g., no mortgage loans, credit cards, lines of revolving credit, student loans, etc.) This may make it difficult to get a loan, as an individual without a credit history is an unknown to banks and lending institutions—lenders do not know if such an individual will pay their debts in a timely manner or allow the debts to go into default. Other consumers do not have a good credit score. For example, a consumer may have received a poor credit score in the past. In some instances, the consumer with the poor credit score may have used alternate financial services that do not report back to one of the credit bureaus. By not reporting the transactions back to one of the credit bureaus, the consumer is not improving their credit score. This may make it difficult to get a loan, as consumers with a poor credit score have shown in the past that they do not pay their debts in a timely manner. It would therefore be desirable to provide additional variables to lenders to help better score a consumer and evaluate the consumer's credit worthiness.

The present invention provides for the creation of a network that lenders (and others) can access to get data variables on a consumer's behavior that will allow the lender to evaluate the consumer's credit worthiness (e.g., consumer's eligibility for a lending product). The data may be used to supplement the credit score information lender's typically receive to help better score a consumer, or may be used instead of the credit score information.

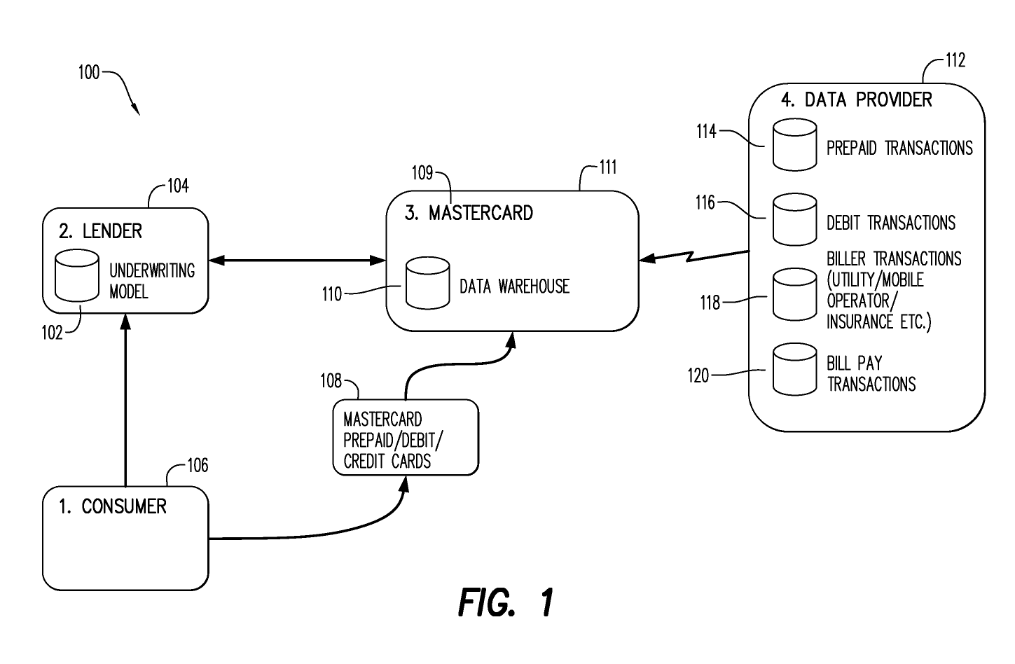

FIG. 1 is a block diagram of a system 100 according to some embodiments of the present invention. In particular, the system 100 includes an underwriting model 102 or credit evaluation platform for use by a lender 104 to determine whether a loan/lending product should be provided to an applicant 106. In one or more embodiments, the lender 104 will use the transactions data/data summary, further described below, as an additional variable in the underwriting model 102 to evaluate credit risk. As used herein, the terms “underwriting model” and “credit evaluation platform” are used interchangeably. The underwriting model 102 is applied, in some embodiments, after it is automatically determined that the applicant 106 or consumer meets at least one criterion for receiving a lending product. As used herein, the terms “applicant” and “consumer” are interchangeable. In some embodiments, at least one criterion for receiving a lending product is that the applicant 106 has one or more existing payment products 108. Other suitable criteria may be used. As used herein payment products may refer to an account associated with one of prepaid cards, debit cards, credit cards, and any other suitable payment product.

The underwriting model 102 might be, for example, associated with a Personal Computer (PC), laptop computer, an enterprise server, a server farm, and/or a database or similar storage devices. The underwriting model 102 may, according to some embodiments, be associated with a credit card company.

According to some embodiments, an “automated” underwriting model 102 may facilitate determination of a consumer's credit worthiness. For example, underwriting model 102 may automatically output an evaluation of a consumer's credit worthiness per the consumer's payment product transaction information. In some embodiments, the underwriting model 102 may also automatically output the terms for providing a particular lending product. As used herein, the term “automated” may refer to, for example, actions that can be performed with little (or no) intervention by a human.

As used herein, devices, including those associated with the underwriting model 102 and any other devices described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

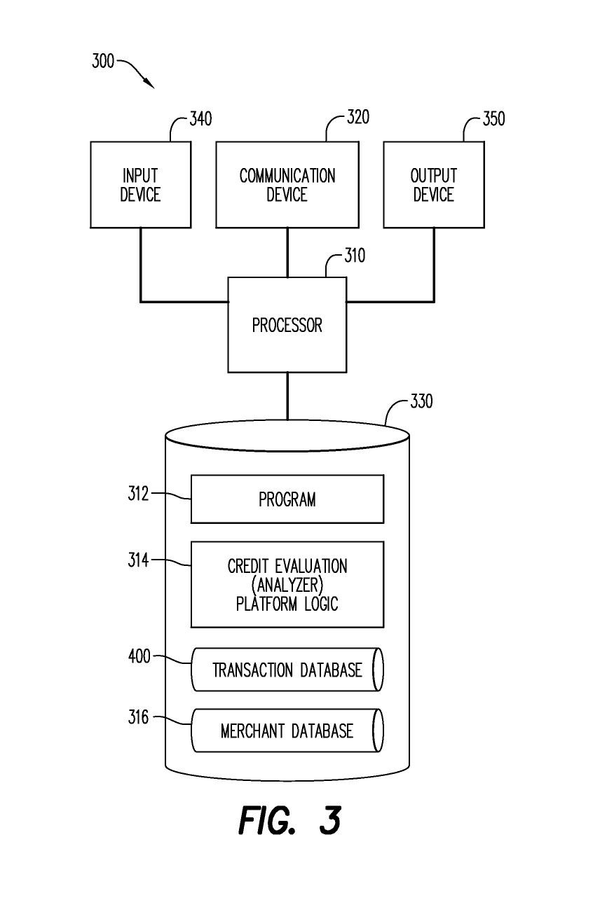

The underwriting model 102 may retrieve transaction information from a data warehouse or database 110 and output transaction information and a creditworthiness evaluation, such as by outputting the transaction information and/or a summary of the transaction data and an evaluation of the applicant 106 to an external device (FIG. 3). In some embodiments, the transactional database 110 is populated with information provided by a primary data source/provider 109, such as MasterCard®. The transaction database 110 might be associated with, for example, payment accounts, such as credit card, or bank accounts (e.g., debit cards) or prepaid cards provided by the primary data provider 109. The transaction database 110 may be locally stored or reside remote from the underwriting model 102. As will be described further below, the transaction database 110 may be used by the underwriting model 102 to generate an evaluation of an applicant's creditworthiness.

According to some embodiments, the underwriting model 102 communicates transaction information and an evaluation to an external device, such as by transmitting an electronic file to an email server, a workflow management system, etc. In other embodiments, the underwriting model 102 might store transaction information and evaluations in a transaction information and evaluation database (not shown).

Although a single underwriting model 102 is shown in FIG. 1, any number of such devices may be included. Moreover, various devices described herein might be combined according to embodiments of the present invention. For example, in some embodiments, the underwriting model 102 and transaction database 110 might be co-located and/or may comprise a single apparatus.

In accordance with some embodiments, the systems and methods described herein provide a framework to determine a consumer's credit worthiness based on transaction information associated with payment product accounts. For example, a payment card may be presented by a cardholder (e.g., consumer/applicant 106) to make a payment. By way of example, and without limiting the generality of the foregoing, a payment card can be a credit card, debit card, charge card, stored-value card, or prepaid card or nearly any other type of financial transaction card. Further, as used herein, the term “issuer” or “attribute provider” can include, for example, a financial institution (e.g., bank) issuing a card, a merchant issuing a merchant specific card, a stand-in processor configured to act on behalf of the card-issuer, or any other suitable institution configured to issue a payment card. As used herein, the term “transaction” can be associated with, for example, a merchant, a merchant terminal, an automated teller machine (ATM), or any other suitable institution or device configured to initiate a financial transaction per the request of the account owner.

As described above, the information in the transaction database 110 may be associated with, for example, the primary data provider 109, such as a “payment card processing system” or “credit card processing networks”, such as the MasterCard® network that allows account owners/consumers/applicants 106 to use payment cards 108 issued by a variety of issuers to shop at a variety of merchants.

The information in the transaction database 110 may also be associated with/received from a secondary data provider/source 112. In some embodiments, the secondary data provider 112 is separate and distinct from the primary data provider 109. The secondary data provider 112 may be, for example, banks, billers and prepaid programs, and may provide information such as, for example, prepaid transactions 114, debit transactions 116, biller transactions (utility/mobile operators/insurance etc.) 118 and bill pay transactions 120, which may be remote. As will be further described below, in some embodiments, the secondary data provider 112 connects directly to the primary data provider 109, which may then enable connectivity to all parties that are connected to the primary data provider 109 (e.g., merchants, issuers, acquirers and other parties connecting through an application programming interface (API)).

The transaction database 110, in some embodiments may further store a “business classification,” which is a group of merchants and/or businesses, by the type of goods and/or service the merchant and/or business provides. For example, the group of merchants and/or businesses can include merchants and/or businesses which provide similar goods and/or services. In addition, the merchants and/or businesses can be classified based on geographical location, sales, and any other type of classification, which can be used to associate a merchant and/or business with similar goods, services, locations, economic and/or business sector, industry and/or industry group.

The transaction database 110 may also store a “merchant category code” or “MCC,” which is a four-digit number created by a credit card company, such as MasterCard® or VISA®, and assigned to a business by the acquirer when the business first starts accepting one of these cards as a form of payment. The MCC is used to classify the business by the type of goods or services it provides. For example, in the United States, the merchant category code can be used to determine if a payment needs to be reported to the IRS for tax purposes. In addition, Merchant Category Codes (or “MCCs”) are used by card issuers to categorize, track or restrict certain types of purchases.

In accordance with some embodiments, data associated with payment card transactions is stored within the transaction database 110. The data may include, for example, an account identifier, a merchant identifier, a time of day of the transaction, a date of the transaction, a listing of sales amount for each payment card transaction including the type of goods and/or services sold, a total number of goods and/or services sold in each transaction, a total sales amount for each transaction (e.g., gross dollar amount), the type of payment product used (payment description), the date payment was due, and the date payment was made.

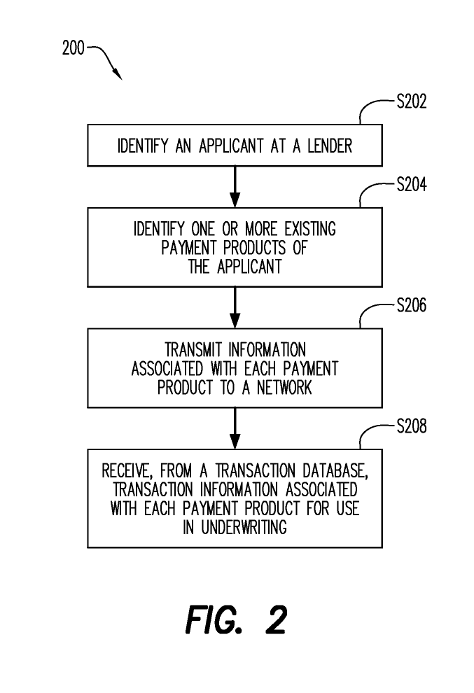

FIG. 2 illustrates a method 200 that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

At S202, the applicant 106 may be identified at the lender 104. For example, the applicant/consumer 106 applies for a lending product (e.g., an installment loan) at the lender 104. The applicant 106 may apply for the loan from home, work, at a brick and mortar lender, online etc. In some embodiments, the applicant 106 may provide their name and address.

At S204, one or more existing payment products of the applicant 106 may be identified. In some embodiments, the payment product type (e.g., MasterCard® credit/debit/prepaid card) is identified. In some embodiments, the life of the payment product (how long the applicant has had the payment product), and/or whether payment is presently overdue for the product is also identified. In some embodiments, the payment product type is identified by a primary account number (PAN), and ownership is validated by one or more of a card verification value (CVV), a card verification code (CVC), expiration date, and billing address of the applicant. Other suitable identification means may be used. In this way, an applicant can quickly be identified via just a PAN and a verification code. In some embodiments, the underwriting model 102 is applied, via a processor, to automatically determine whether the applicant 106 meets at least one criterion for receiving a lending product. In one or more embodiments, identifying one or more payment products 108 is a threshold or criteria for applying the underwriting model 102. In some embodiments, the applicant 106 provides the PAN for each of their payment products, while in other embodiments the applicant 106 provides one PAN, and other payment products associated with the account owner of the PAN are provided. In some embodiments, the underwriting model 102 is used to obtain transaction data for the payment products associated with the applicant 106. In some embodiments, the transactions may be listed individually, or a summary of the transactions may be provided. As used herein, the term “transaction data” may apply to either individual transactions or a summary of multiple transactions. In the depicted embodiment, after the applicant 106 meets at least one criterion for receiving the lending product, the underwriting model 102 creates a request for transaction data to be generated by the transaction database 110. The type and/or number of payment products may act as a filter to determine the information obtained from the transaction database 110 in one or more embodiments. For example, for a first type of payment product all of the data in the transaction database 110 is returned/obtained and for a second type of payment product, only the bill payment information (e.g., date and amount paid) is returned.

At S206, information associated with each payment product 108 may be transmitted to a computer network 111. In some embodiments, the network is managed by the primary data provider 109. In some embodiments, the information is provided by the primary data provider 109 (e.g., the issuer of the payment product). For example, the applicant 106 who has used a MasterCard® issued credit/debit/prepaid card applies for a lending product (e.g., installment loan) at the lender 104, and then MasterCard® is the primary data provider 109, and the provider/source of the information. The information associated with each payment product may be, in some embodiments, individual transactions or summarized transaction behavior. In some embodiments, the method 200 includes summarizing the transaction information of the applicant over the last “n” months. The information may include, for example, bill payment history, cash usage, frequency of usage, etc. Other information may be included. In some embodiments, secondary applicant information provided by the secondary data provider/source 112 (e.g., other data providers such as banks, billers, prepaid programs) is received in the transaction database 110. In one or more embodiments, the information may be provided by at least one of the primary data provider 109 and the secondary data provider 112. In some embodiments, the primary data provider 109 (e.g., MasterCard®) acts as a clearinghouse, or network hub, that collects information primarily from the applicant's payment product usage associated with that primary data provider 109, and also from secondary data providers 112 and distributes it to those accessing the network, such as lenders (via the underwriting model 102, for example), and, in some embodiments, even the secondary data providers 112 themselves for evaluation purposes, for example. In some embodiments, the secondary data provider(s) 112 may connect directly to the primary data provider 109, which then may enable connectivity to all parties that are connected to the primary data provider 109 (e.g., Merchants, Issuers, Acquirers and other parties such as lenders) through an application programming interface (API). Using information from primary data providers 109 and secondary data providers 112 provides a better evaluation of an applicant's credit worthiness.

At S208, transaction information associated with each payment product may be received from the transaction database 110 for use in underwriting (e.g., providing a loan product and the terms for the loan product). In one or more embodiments, the transaction information is associated with at least one of bill payment history, cash usage, frequency of payment product usage and deposit information. In some embodiments, the underwriting model 102 retrieves the information from the transaction database 110. In some embodiments, for example, the lender 104 may be interested in knowing whether the applicant 106 earns more than they spend. Transaction information that indicates how much money is deposited on a payment product (e.g., a debit card) each month (e.g., earnings) and the bills being paid by the payment product may be used to determine whether the applicant 106 earns more than they spend, and to evaluate applicant consistency/behavior (e.g., whether the bills are paid on time).

In some embodiments, the lender 104 may use the underwriting model 102 to query an applicant's spending, for example, to determine whether to offer a lending product to the applicant and/or what terms to offer with the lending product. The lender 104 determines how the data is categorized when it is returned, in one or more embodiments. For example, in some embodiments, the applicant spending data may be returned as at least one of:
Spending by merchant category code over the last 6 months;
Spending by bill pay merchant (utility, insurance, mobile, cable etc.) over the last 6 months. This may show a date of spending by merchant and an amount, and may allow the issuer/lender to see whether the applicant has consistently paid the bills over time;
Cash use versus merchant spending over the last 6 months. This may enable lenders/issuers to understand how the applicant spends. In some embodiments, cash use is more risky;
Total spending on a monthly/weekly basis over the last 6 months. This may show consistency to better evaluate the risk in lending to the applicant; and
Card life, which is the total active life of the card in months. In some embodiments, a card is considered inactive when not used for 90 days.

In this way, data associated with payment product/card transactions may be analyzed and evaluated to automatically determine whether an applicant is eligible for a lending product (“credit-worthy”) and/or to determine the terms that should be offered with the lending product. One of the benefits of embodiments of the invention is how easy it can be to determine an applicant's credit worthiness. For example, an applicant can be deemed “credit-worthy” with only a history of pre-paid card transactions.

Note that the embodiments described herein may be implemented using any number of different hardware configurations. For example, FIG. 3 illustrates a credit evaluation platform 300 that may be, for example, associated with the system 100 of FIG. 1. The credit evaluation platform 300 comprises a processor 310, such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more transaction databases. The credit evaluation platform 300 further includes an input device 340 (e.g., a computer mouse and/or keyboard to enter information about transactions) and an output device 350 (e.g., a computer monitor or printer to output a transaction information report and/or evaluation).

The processor 310 also communicates with a storage device 330. The storage device 330 may comprise any appropriate information storage device, including combinations of magnetic storage devices (e.g., a hard disk drive), optical storage devices, mobile telephones, and/or semiconductor memory devices. The storage device 330 stores a program 312 and/or analyzer platform logic 314 for controlling the processor 310. The processor 310 performs instructions of the programs 312,314, and thereby operates in accordance with any of the embodiments described herein. For example, the processor 310 may identify an applicant at a lender, identify one or more existing payment products of the applicant, transmit information associated with each payment product to a network, and retrieve transaction information associated with payments made via a payment product account (e.g., a credit card account associated with an account owner) from the transaction database 110. The retrieved transaction information may then be analyzed by the processor 310 to automatically determine whether the applicant is “credit-worthy.”

The programs 312,314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” or “retrieved” by or “transmitted” to, for example: (i) the credit evaluation platform 300 from another device; or (ii) a software application or module within the credit evaluation platform 300 from another software application, module, or any other source.

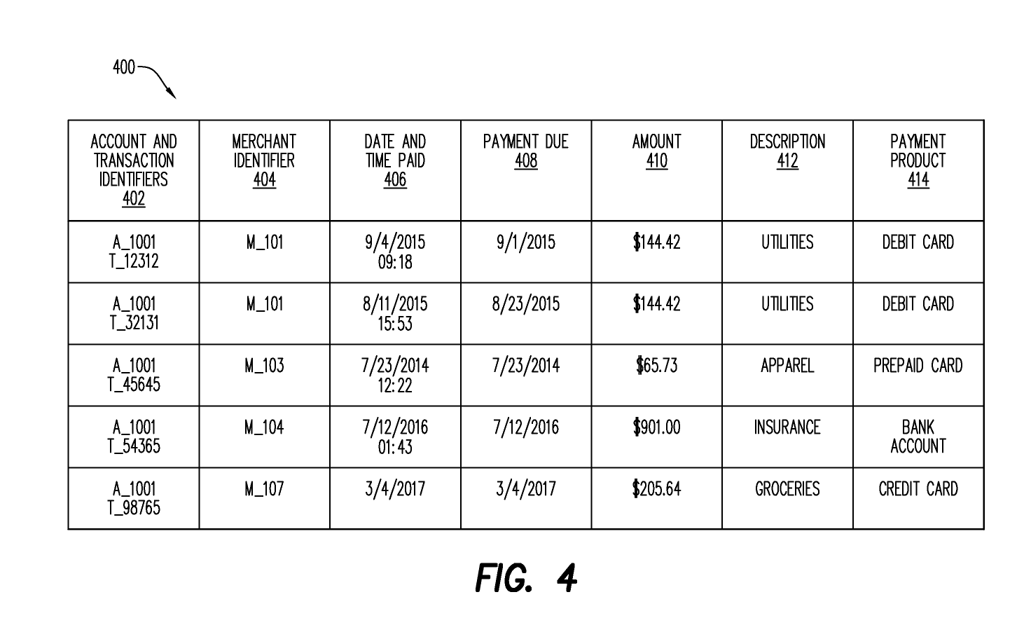

In some embodiments (such as shown in FIG. 3), the storage device 330 further stores a transaction database 400/110 and a merchant database 316. Some examples of databases that may be used in connection with the credit evaluation platform 300 will now be described in detail with respect to FIGS. 3 and 4. Note that the databases described herein are only examples, and additional and/or different information may actually be stored therein. Moreover, various databases might be split or combined in accordance with any of the embodiments described herein.

Referring to the merchant database in FIG. 3, in some embodiments, the merchant database 316 may include, for example, entries identifying merchants involved in the transactions. The merchant database 316 may be created and updated, for example, based on information electrically received on a periodic basis.

Referring to FIG. 4, a table is shown that represents the transaction database 400/110 that may be stored in the credit evaluation platform 300 according to some embodiments. The table may include, for example, entries identifying transactions that have been processed via a payment product (e.g., debit card, pre-paid card, bank account and credit card transactions). The table may also define fields 402, 404, 406, 408, 410, 412, 414 for each of the entries. The fields 402, 404, 406, 408, 410, 412, 414 may, according to some embodiments, specify: an account and a transaction identifier 402, a merchant identifier 404, a date and time paid for the transaction 406, a date the payment is/was due 408, an amount 410, a description 412, and the type of payment product used 414. The transaction database 400 may be created and updated, for example, based on information electrically received on a periodic basis.

The account identifier 402 may be, for example, a unique alphanumeric code identifying a payment account, such as a Primary Account Number (“PAN”). The transaction identifier 402 might be associated with a particular transaction (e.g., a purchase at a clothing store). The date and time paid 406 may indicate when the transaction was paid for and payment due 408 may indicate the date the payment was due. This information may enable the tracking of the consistency of bill payments (e.g., whether payment was made approximately the same date every month, and if the payment was same amount or big fluctuations). The amount 410 may indicate the monetary amount of the transaction. The description 412 may indicate what was purchased in the transaction (e.g., a general indication that a payment product was used to pay for utilities, a type of goods or services typically offered by the merchant, etc.). The payment product 414 may indicate the type of payment product (e.g., debit card, pre-paid card, bank account or credit card, etc.) used to pay for the transaction. In some embodiments, the information in at least one of the fields specified by 402, 404, 406, 408, 410, 412, and 414 may be used to determine an applicant's credit-worthiness. Additionally or alternatively, in some embodiments, applicant spending data related to at least one of spending by merchant category code over the last 6 months, spending by bill pay merchant over the last 6 months, cash use versus merchant spending over the last 6 months, total spending on a monthly/weekly basis over the last 6 months, and card life may be used to determine an applicant's credit-worthiness.

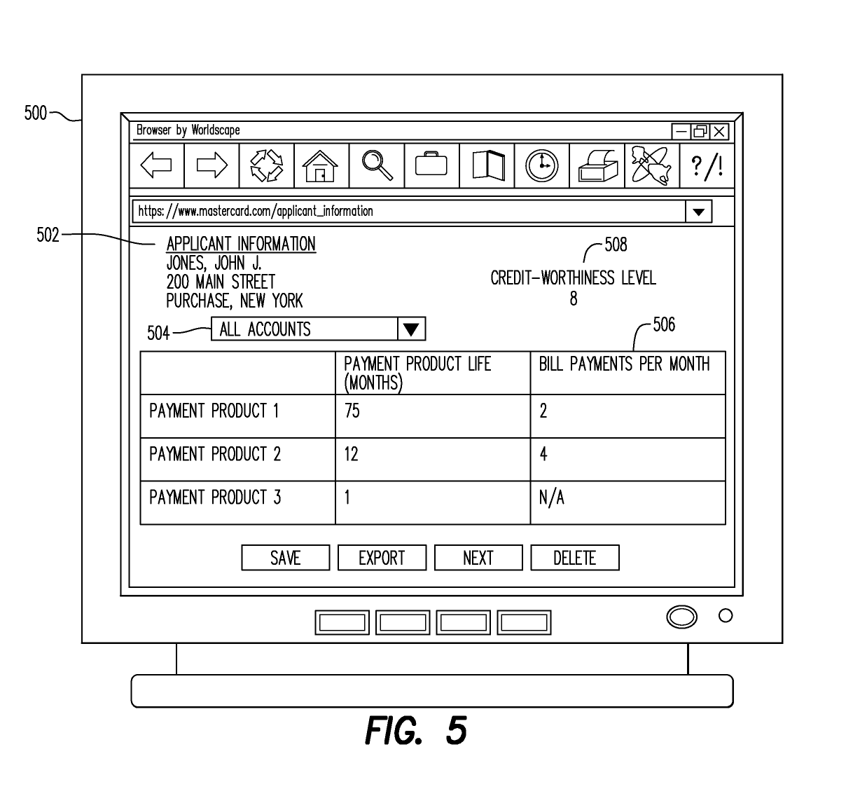

FIG. 5 is an example of a display 500 that might be provided in accordance with some embodiments. In particular, the lender 106 might enter applicant information 502 and select 504 which type of payment product account information should be included on the display (e.g., all payment product account types). Moreover, as illustrated in FIG. 5, the credit evaluation platform/underwriting model may generate and display 506 the payment product life and the number of bill payments per month for the particular payment product. The credit evaluation platform/underwriting model may also generate and display other variables, including but not limited to, a cash versus POS spending percentage on a monthly basis and an amount spent per merchant category code. Additionally, in some embodiments, the credit evaluation platform/underwriting model may generate a score or other “financial health” 508 associated with applicant's payment product. The credit-worthiness level might indicate, for example, how likely it is that the applicant will repay their loans. In one or more embodiments, the financial health score may be associated with how well the applicant manages his/her money. In one or more embodiments the financial health score may be a variable in evaluating a consumer's credit worthiness.

The present invention has been described in terms of several embodiments solely for the purpose of illustration. Persons skilled in the art will recognize form this description that the invention is not limited to the embodiments described, but may be practiced with modifications and alterations limited only by the spirit and scope of the appended claims.

What is claimed is:

1. A method, comprising:
identifying an applicant at a lender;
identifying one or more existing payment products of the applicant;
transmitting information associated with each payment product to a network; and
receiving, from a transaction database, transaction information associated with each payment product for use in underwriting.

2. The method of claim 1, further comprising:
evaluating the transaction information to determine the applicant's eligibility for a lending product.

3. The method of claim 1, wherein the payment product is an account associated with one of a credit card, a debit card and a pre-paid card.

4. The method of claim 1, wherein the transaction information comprises at least one of: (i) an account identifier, (ii) a merchant identifier, (iii) a date, (iv) a time of day, (v) a payment amount, (vi) a payment description, and (vii) a payment due date.

5. The method of claim 1, further comprising:
summarizing the transaction information over the last ‘n’ months.

6. The method of claim 1, wherein the transaction information is associated with at least one of: (i) bill payment history, (ii) cash usage, (iii) frequency of payment product usage and (iv) deposit information.

7. The method of claim 1, further comprising:
receiving, in the transaction database, secondary applicant information from a data provider.

8. The method of claim 7, wherein the data provider is at least one of a bank, a biller, and a pre-paid program.

9. The method of claim 7, wherein the secondary applicant information is at least one of prepaid transactions, debit card transactions, biller transactions and remote bill pay transactions.

10. The method of claim 1, further comprising:
applying an underwriting model, via a computer processor, after identifying one or more existing payment products of the applicant to automatically determine whether the applicant meets at least one criterion for receiving a lending product.

11. The method of claim 10, further comprising:
creating a request for transaction data to be generated by the transaction database when the applicant meets at least one criterion for receiving the lending product.

12. The method of claim 1, wherein information associated with each payment product is at least one of a permanent account number (PAN), card verification value (CVV), card verification code (CVC), billing address, and expiration date.

13. A non-transitory, computer-readable medium having stored therein instructions that, upon execution, cause a computer processor to perform a method, the method comprising:
identifying an applicant at a lender;
identifying one or more existing payment products of the applicant;
transmitting information associated with each payment product to a network; and
receiving, from a transaction database, transaction information associated with each payment product for use in underwriting.

14. The medium of claim 13, wherein the payment product is an account associated with a credit card, a debit card and a pre-paid card.

15. The medium of claim 13, wherein the transaction information is associated with at least one of: (i) bill payment history, (ii) cash usage, (iii) frequency of payment product usage and (iv) deposit information.

16. The medium of claim 13, further comprising:
receiving, in the transaction database, secondary applicant information from a data provider.

17. The medium of claim 16, wherein the secondary applicant information is at least one of prepaid transactions, debit card transactions, biller transactions and remote bill pay transactions.

18. An apparatus, comprising:
a transaction database storing transaction information associated with one or more payment products; and
a credit evaluation platform to: (i) identify an applicant at a lender, (ii) identify one or more existing payment products of the applicant, (iii) transmit information associated with each payment product to a network, and (iv) receive, from a transaction database, transaction information associated with each payment product for use in underwriting.

19. The apparatus of claim 18, wherein the payment product is an account associated with a credit card, a debit card and a pre-paid card.

20. The apparatus of claim 18, wherein the transaction information is associated with at least one of: (i) bill payment history, (ii) cash usage, (iii) frequency of payment product usage and (iv) deposit information.
